(19) United States
(12) Patent Application Publication
(10) Pub. No.: US 2007/0198636 A1
(43) Pub. Date: Aug. 23, 2007

(54) Method and system for distributing file

(76) Inventors: Hirohisa Inamoto, Kanagawa (JP); Takanori Yano, Kanagawa (JP); Satoshi Ouchi, Tokyo (JP); Makoto Hino, Kanagawa (JP); Hiroaki Suzuki, Chiba (JP); Kenji Kagitani, Kanagawa (JP); Maiko Takenaka, Kanagawa (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/698,637

(22) Filed: Jan. 26, 2007

(30) Foreign Application Priority Data
Jan. 27, 2006 (JP) 2006-019553
Dec. 28, 2006 (JP) 2006-356359

(51) Int. Cl. G06F 15/16

(52) U.S. Cl. 709/203

(57) ABSTRACT

A server that manages a distribution of a file and at least two client devices including a first client device that requests the file and a second client device that transfers the file are connected via a network. The second client device includes a storing unit to store the file, and a transferring unit that transfers the file to the first client device. The server includes a managing unit that manages the file, a distributing unit that distributes the file in response to a request from the first client device, and a reward managing unit that manages a reward for the second client device that participated in a transfer of the file.

### PRIORITY

The present document claims priority to and incorporates by reference the entire contents of Japanese priority document, 2006-019553 filed in Japan on Jan. 27, 2006, and 2006-356359 filed in Japan on Dec. 28, 2006.

### BACKGROUND OF THE INVENTION

1. Field of the Invention

The present invention relates to a technology for distributing a file through a network.

2. Description of the Related Art

The predominant method of distributing a file over a Web is a so-called client-server scheme in which a file is transferred to a specific server, which a viewer accesses for downloading to a viewer's client personal computer (PC). In the previous era where files to be on public view on the Web were only small files, such as those for characters and a small amount of images with low image quality, small-sized moving images, and free software, even when many client PCs accessed a specific server, communication was possible without many problems.

However, in recent years, with the development of wideband communication networks, such as Fiber to the Home (FTTH) and ×Digital Subscriber Line (×DSL), so-called broadband contents have been expanded, which contain large-amount files, such as moving images, music, and high-quality images. With such an expansion, a large problem has become apparent in the client-server scheme.

That is, if the time for each server to access one server becomes long because of large file size, the number of users accessing one server is increased. On the other hand, a band in which the server can communicate at one time is limited, and the band is divided by the number of accessing users. Therefore, a band allocated to each user is extremely small.

In general, to enjoy an excellent level of user satisfaction, it is required to allow contents desired by the user to be immediately distributed. For widespread use of broadband contents, such a small band as explained above is not preferable. For the distributor to solve this problem in a client-server communication scheme, it is required to increase the number of servers and widen a network band surrounding the servers. However, as a matter of course, such an expansion of the distribution environment puts an enormous load on the distributor, and becomes a barrier to newly entering broadband content business. Moreover, this expansion of the distribution environment puts a load on users in the form of an increase in price of contents. In this manner, the client-server communication does not promote penetration of broadband contents.

In recent years, a communication scheme called Peer to Peer (hereinafter abbreviated as P2P) has become more prevalent. The P2P communication scheme has a feature in which client PCs participating in communication are connected to each other evenly (as peers), as its name suggests, and instead of referring to a file residing on the server, a client PC refers to a file on another client PC.

When the P2P communication scheme is used, a client PC retaining a file primarily distributed by the distributor acts as a server, and then another client PC obtaining the file there from further acts as a server. Therefore, the load on the distribution server can be decentralized. With this, the distributor can distribute contents at low cost. As a result, a consideration required for the user to obtain contents can be small.

However, file distribution using P2P has various problems. First, the merits given to the user over participating in the transfer is small. If the merits are given only to the distributor at the time of distributing a file using P2P, the user would not be willing to participate in transfer.

Another problem is illegal file sharing. In the P2P communication scheme, information does not necessarily pass through a specific route, and it is therefore extremely difficult to manage information distribution. For this reason, in P2P communication, how many files have been circulated cannot be known, and which receiver the file has been transferred to cannot be known. Thus, there is no way of charging for contents. Furthermore, even if a copyrighted file is shared among users without permission, the distributor does not know.

To cope with these problems, there is a scheme of using a hybrid P2P scheme in which, while a file itself is transferred through P2P, its communication record is managed by the server. Note that a communication scheme of purely exchanging files among users is called a pure P2P scheme.

However, even when file exchanges among users are monitored through the hybrid P2P scheme, there may be the case where a file obtained by the user is illegally exchanged through another communication scheme. To address such a case, a scheme can be envisioned in which a file itself is encrypted and only its decryption key is distributed through the client-server scheme.

However, if all encrypted files have been encrypted in the same manner, a key obtained by a certain user may be distributed together with the file. Moreover, if files distributed to separate users are encrypted separately, the merits of P2P communication cannot be enjoyed.

In addition, there may be a scheme in which authentication is performed every time a file is used. Such authentication for every use does not fit the user's sense of purchasing a file. Also, for example, it takes a long time for authentication to complete accesses are concentrated on an authentication server. As such, the convenience of the users is disadvantageously impaired.

To cope with the problems, there is a system known and disclosed in Japanese Patent Application Laid-Open No. 2002-314525, in which a reward is paid based on file transfer. In the system disclosed in this gazette, a file generator and a file distributor are present separately, and the file generator pays a reward to the file distributor according to the number of files distributed by the file distributor. When the file generator directly distributes a file, there may be the case in which a provided band of the distribution server is different from a band actually required. This incurs a risk of loosing sales opportunities, or a risk of having to prepare an unnecessarily large band, thereby causing a superfluous cost. On the other hand, when the file distributor takes on all tasks of distribution from various file generators, a difference between a predicted band and an actually required band can be solved, thereby reducing the risk explained above.

However, since the technology disclosed in the gazette above is based on the client-server scheme, the transferor and the receiver do not change their places, that is, a file purchaser does not change its place. In other words, from the user's point of view, there is merely an involvement of an intermediary in the technology disclosed in the gazette above, which means an increase in price from the file purchaser's point of view.

### SUMMARY OF THE INVENTION

A method and system for distributing file are described. In one embodiment, a system in which a server that manages a distribution of a file and at least two client devices including a first client device that requests the file and a second client device that transfers the file are mutually connected via a network, wherein the second client device includes a storing unit that stores therein the file distributed by the server, and a transferring unit that transfers the file to the first client device, and the server includes a managing unit that manages the file, a distributing unit that distributes the file in response to a request from the first client device, and a reward managing unit that manages a reward for a transfer of the file to be issued to the second client device that participated in the transfer of the file.

### BRIEF DESCRIPTION OF THE DRAWINGS

FIG. 1 is a drawing of the configuration of a file distribution system according to an embodiment of the present invention;

FIG. 2 is a drawing for illustrating a Vigenere square;

FIG. 3 is a flowchart of the operation of a file requesting client according to the embodiment of the present invention;

FIG. 4 is a flowchart of the operation of a transfer management server according to the embodiment of the present invention;

FIG. 5 is a flowchart of the operation of a transfer client according to the embodiment of the present invention;

FIG. 6 is a drawing that schematically depicts classification of a user layer in commodity distribution;

FIG. 7 is a drawing of a virtual network of the file distribution system according to the embodiment of the present invention;

FIG. 8 is a drawing of an example of a distribution-history management table;

FIG. 9 is a drawing of an example of a transfer-client management table;

FIG. 10 is a drawing of the configuration of transfer request information; and

FIG. 11 is a sequence flow from a file distribution request from a fourth client to the arrival of the file at the fourth client.

### DETAILED DESCRIPTION OF THE PREFERRED EMBODIMENTS

Embodiment of the present invention to at least partially solve problems in the conventional technology.

A system according to one embodiment of the present invention includes a server that manages a distribution of a file and at least two client devices including a first client device that requests the file and a second client device that transfers the file mutually connected via a network. The second client device includes a storing unit that stores therein the file distributed by the server, and a transferring unit that transfers the file to the first client device. The server includes a managing unit that manages the file, a distributing unit that distributes the file in response to a request from the first client device, and a reward managing unit that manages a reward for a transfer of the file to be issued to the second client device that participated in the transfer of the file.

A method according to another embodiment of the present invention is for distributing a file to a first client device that requests the file by transferring the file from a server that distributes the file, through a network. The method includes file distributing, which includes the server distributing the file, when a request for the file is received from the first client device, to a second client device that transfers the file to the first client device; file transferring, which includes the second client device transferring the file to the first client device; and reward issuing which includes the server issuing a reward to second client devices that participated in a transfer of the file.

The above and other objects, features, advantages and technical and industrial significance of this invention will be better understood by reading the following detailed description of presently preferred embodiments of the invention, when considered in connection with the accompanying drawings.

Exemplary embodiments of the present invention will be explained in detail below with reference to the accompanying drawings.

Embodiments of the present invention suggest a file communication system based on the P2P communication scheme in which some reward is given to a user having a client participating in a transfer. In one embodiment, a framework is provided that allows a file distributor to distribute files at low cost without impairing its benefit, to allow a user to easily obtain a file, and to give a merit to user in participating as a transferor in a P2P network for content distribution.

That is, in one embodiment, the present invention, a purchaser and a transferor can change their places as appropriate, and the reward obtained through transfer can be used as purchase funds for files. Therefore, the file price is practically decreased. Note that the embodiment is not restricted to the one explained below, and can be variously modified within a range not deviating from the scope of the present invention.

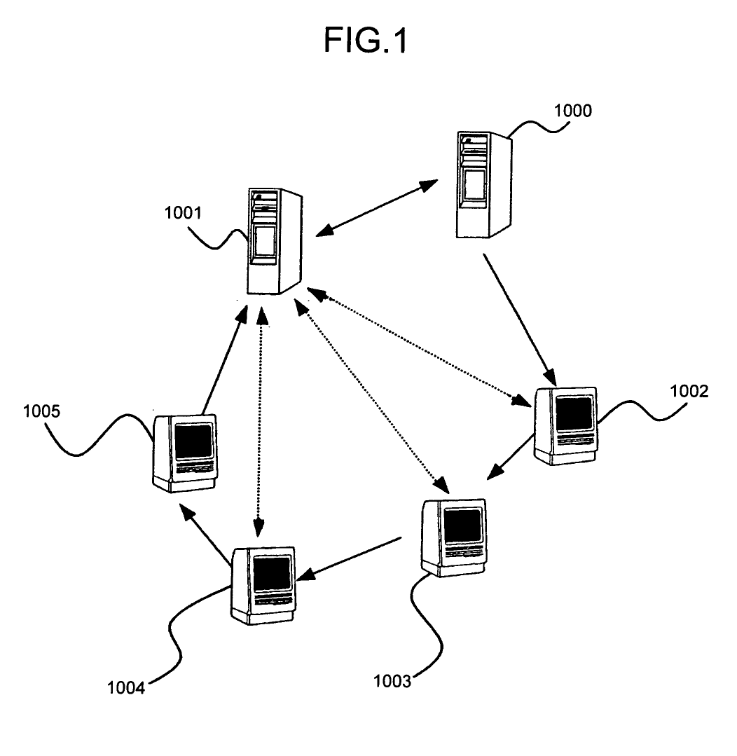

FIG. 1 is a drawing of an example of the configuration of the file distribution system according to the embodiment, depicting a flow of exchanges of a distribution file, an encryption key, and a decryption key.

As depicted in FIG. 1, in the file communication system according to the embodiment, a distribution server 1000, a transfer management server 1001, a first client 1002, a second client 1003, a third client 1004, and a fourth client 1005 are in a mutually connectable state through a network. It is also assumed in FIG. 1 that dotted lines represent exchanges of an encryption key or a decryption key, whilst solid lines represent exchanges of a distribution file.

First, a file distributor prepares in advance the distribution server 1000 and the transfer management server 1001.

When a certain client, for example, the fourth client 1005, issues a file distribution request to the transfer management server 1001, the transfer management server 1001 determines a file distribution source. At this time, the file distribution source is either the distribution server 1000 or a client to which the file has already been distributed by the distribution server 1000 (hereinafter, a “distribution-source client”), for example, the first client 1002. Here, a determination by the transfer management server 1001 of which one of the distribution server 1000 and any client (distribution-source client) is a distribution source is performed by referring to a distribution-history management table in a distribution-history management database (DB). An example of the distribution-history management table is depicted in FIG. 8. First, the transfer management server 1001 checks the contents of the file distribution request received from the fourth client 1005. The transfer management server 1001 then refers to the distribution-history management table based on the file name of the file requested for distribution by the file distribution request, thereby obtaining information about the client having the file request for distribution. When no client has the file requested for distribution, the transfer management server 1001 selects the distribution server 1000 as a distribution source. When a client having the file requested for distribution is present, the transfer management server 1001 selects one of the clients having the file requested for distribution as a transfer source (distribution-source client). If a plurality of clients having the file requested for distribution are present, one of the clients is selected as a distribution-source client based on reward conditions for each client when becoming a distribution-source client. By referring to a transfer-client management table, which will be explained further below, to obtain the reward conditions for each client, a client satisfying the conditions is selected as a distribution-source client. The configuration may be such that a table registered therein reward conditions for each client when becoming a distribution-source client is separately provided. Alternatively, one of the clients having the file requested for distribution may be randomly selected without depending on the reward conditions and other factors.

When the file distribution source is the distribution server 1000, the following operation is performed.

The transfer management server 1001 first notifies the distribution server 1000 of a communication destination (destination), which is the fourth client 1005, and transmits a prepared encryption key for the fourth client 1005. The distribution server 1000 then encrypts the file to be distributed by using the encryption key.

On the other hand, the fourth client 1005 receiving the file pays a consideration to the distributor for the use of the file, thereby capable of obtaining the encryption key present in the transfer management server 1001. By decrypting the file with the use of this encryption key, the distributed file can be used. Here, at the time of decrypting the file, user-specific information, such as an IP address, is added to a head portion of the file, for example. With the user-specific information being added to the file in this manner, the user distributing the file to an indefinite number of clients can be specified based on the file distributed over the network.

In this manner, according to the embodiment, an encryption is performed for each file at each client, thereby suppressing unauthorized sharing of the encryption key. Also, even when the file is decrypted, the user information can be embedded in the file, thereby also suppressing illegal sharing of the decrypted file.

The transfer management server 1001 determines a transfer route. A determination of a transfer route includes a determination of clients participating in transfers (such clients are hereinafter referred to as “transfer clients”) and a determination of an order of passing through the transfer clients.

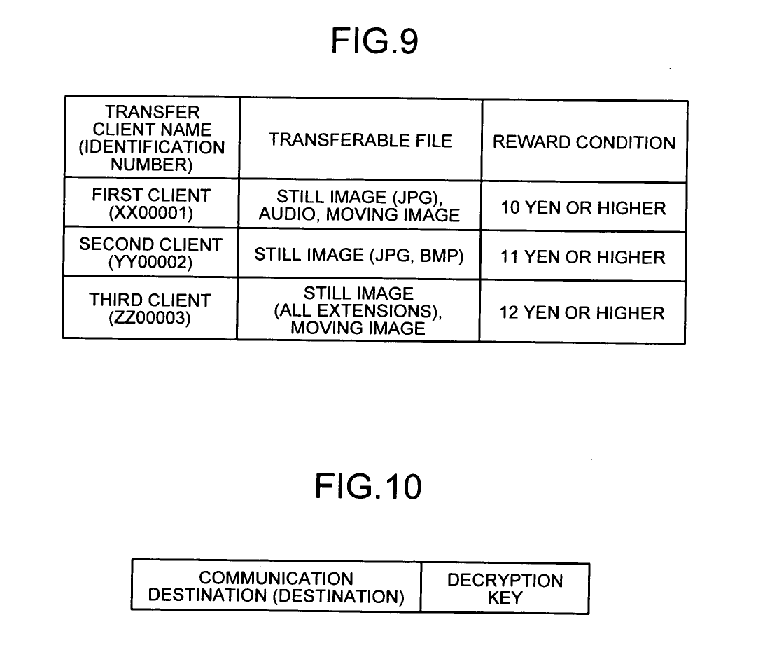

The transfer management server 1001 refers to the transfer-client management table in a transfer client management DB. The transfer-client management table is a table in which clients that can each serve as a transfer client are registered. An example of the transfer-client management table is depicted in FIG. 9. The transfer management server 1001 refers to the transfer-client management table, and selects several clients from the clients registered in the transfer-client management table as transfer clients. Here, when the distribution-source client is registered as a transfer client in the transfer-client management table, it is preferably that the distribution-source client be not selected as a transfer client. That is, when the name (or the identification number) of the distribution-source client is identical to the name of the client selected from the transfer-client management table, that client is preferably not selected as a transfer client.

Various methods of designing the transfer-client management table can be contemplated. Each transfer client may be simply registered in the transfer-client management table without any classification. Alternatively, registration may be made with a classification by country or area where the clients are present. Still alternatively, registration may be made with classification by communication capability (communication speed, band, or the like) of each transfer client. Also, as depicted in FIG. 9, in the transfer-client management table, conditions (the contents of the target file, the amount of reward, and others) on which each client can participate in transfer as a transfer client can be registered. With such classification and registration, a transfer route satisfying desired conditions can be easily determined.

At this time, it is assumed that the number of transfer clients that are passed through to transfer the file is determined in advance by the distributor. The number of transfer clients to be passed through can be set in advance within a predetermined range having a certain width (for example, six to eight), instead of setting a specific number. With this, the user of the transfer client can be prevented from knowing personal information, such as information indicating which user has obtained which file, by tracing the route to some degree. Also, the distributor may set in advance the number of transfer clients to be passed through within a predetermined range having a certain width (for example, six to eight), instead of setting a specific number, and may select the number of transfer clients from the predetermined range for every distribution at its discretion or based on random numbers.

It is assumed that two clients, that is, the second client 1003, the third client 1004, are selected as the transfer clients, and a file distribution route is determined from the first client 1002, which is a distribution-source client, to the second client 1003 and then the third client 1004, which are transfer clients.

As explained above, according to the embodiment, the number of transfer clients through which the file passes is specified by the file originator, thereby suppressing distribution cost to an arbitrary amount. Therefore, the file distributor can easily use this system. Also, an arbitrary number within the range of the number of transferors (the number of transfer clients) is set as the number of transferors (the number of transfer clients) through which the file passes, thereby preventing each transferor from knowing who desires the file. This leads to protection of personal information of the person desiring the file.

Upon determination of the transfer route, the transfer management server 1001 sends to the distribution-source client a transfer key obtained by combining encryption keys for the respective transfer clients on the transfer route. In this example, the transfer management server 1001 transmits to the first client 1002, which is a distribution-source client, a key for transfer (transfer key) obtained by combining encryption keys for the second client 1003 and the third client 1004.

The first client 1002, which is a distribution-source client, receiving the transfer key uses this transfer key to encrypt the file to be transferred, and then transmits the encrypted file to the second client 1003, which is a transfer client.

The second client 1003 receives the file from the first client 1002, which is a distribution-source client, and receives transfer request information from the transfer management server 1001. The configuration of the transfer request information is depicted in FIG. 10. The transfer request information contains a communication destination (destination) to which the target file is transferred next and a decryption key for the second client 1003.

The second client 1003 receiving the file and the transfer request information decrypts the file with the decryption key for the second client 1003, and then transmits the file to the third client 1004, which is the next transfer client on the transfer route, based on the communication destination (destination) contained in the transfer request information. At this time, the second client 1003 retains the target file in a storage device of the second client 1003. The third client 1004 performs an operation similar to the operation of the second client 1003. That is, the third client 1004 receives the file from the second client 1003, which is a transfer client, and then receives the transfer request information from the transfer management server 1001.

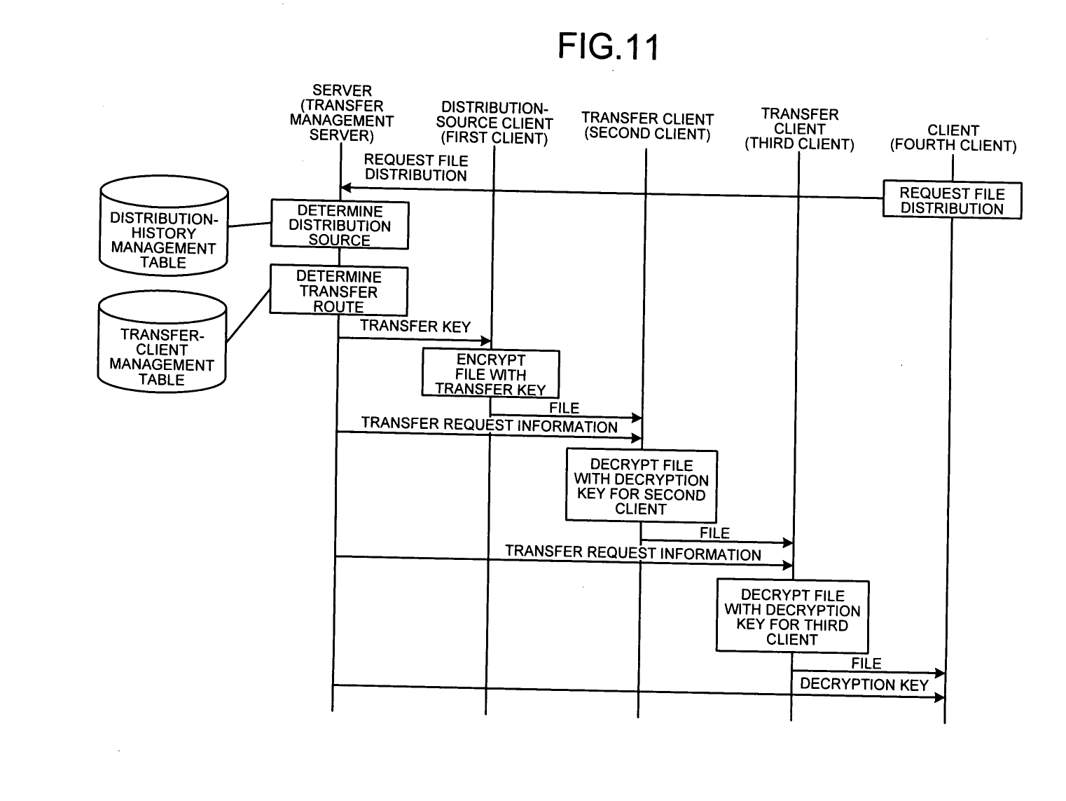

Then, with a decryption key for the third client 1004, the third client 1004 decrypts the file, and then transmits the file to the next transfer client on the transfer route, based on the communication destination (destination) contained in the transfer request information. Similarly, the third client 1004 retains the transfer target file in a storage device of the third client 1004. Then, the file eventually arrives at the fourth client 1005 issuing the file distribution request. A transfer flow explained above, from the file distribution request from the fourth client to the arrival of the file at the fourth client is depicted in FIG. 11. In FIG. 11, the transfer management server 1001 is assumed to be a distribution server. This means that a transfer management server and a distribution server may be combined as one server, or a server having a different function may be included to form a server.

Upon arrival of the file transferred from the third client 1004, the fourth client 1005 notifies the transfer management server 1001 of the arrival of the file. At this time, the first client 1002, the second client 1003, and the third client 1004 each obtain a right of receiving a reward for participating in file distribution (distribution and transfer). From the transfer management server 1001, a reward is transmitted to each client participating in file distribution (distribution and transfer). Here, the reward may be transmitted through a scheme of transmitting (paying) an actual reward, such as a transfer to a bank account or an electronic money transfer, or through a scheme of notifying that an actual reward will be paid in the future.

Since a reward can be obtained by participating in file distribution (distribution and transfer), the file transferors will actively participate in the file distribution system. Also, if the transferor uses the reward obtained at the time of participating in file transfer to purchase a file, for example, the price is practically decreased. This encourages people to purchase files, leading to an increase in benefit of the file distributor.

Furthermore, notification of the occurrence of the reward from the transfer management server 1001 to each client will promote motivation of transfer participants. Here in this case, notification more preferably includes visual and auditory notification to the user of the occurrence of the reward from the client. Such presentation regarding the occurrence of the reward can make the user realize the significance of the participation in a file transfer, thereby further promoting motivation of participation in the file transfer.

In the example explained above, when the distribution source is a distribution-source client, the transfer clients and the transfer route are set for file distribution. A similar process can be performed when the distribution source is the distribution server 1000.

After the file distribution explained above, the transfer management server 1001 updates the distribution-history management table. That is, with the file distribution explained above, the second client 1003 and the third client 1004, which are transfer clients, retain a file 1, and therefore the second client 1003 and the third client 1004 are added to a section of the file 1 in the distribution-history management table.

Then, when a distribution request for the file 1 is issued from the fifth client, the transfer management server 1001 refers to the updated distribution-history management table to obtain information about the clients having the file requested for distribution. In the updated distribution-history management table, the first client 1002, the second client 1003, and the third client 1004 are present as clients having the file requested for distribution. Therefore, any one of these clients is selected as a transfer source (distribution-source client).

Whether the client can be a distribution-source client may be applied in advance by the client, and only the client applying as such may become a distribution-source client. Furthermore, only the client applying as such may be added to the distribution-history management table.

In this manner, the actually-transferred file remains in the client that is present in the course of transfer. Therefore, when a user later desires this file, the user can obtain the file from the clients that have transferred the file. Thus, a situation that allows the file to be easily obtained can be created.

As explained above, according to the embodiment, the possibility of putting an enormous load on a specific server through P2P communication can be eliminated. Therefore, the files remaining in the clients at preceding stages of transfer by repeating encryption in the course of transfer can be in a state where these files have been encrypted differently for each client.

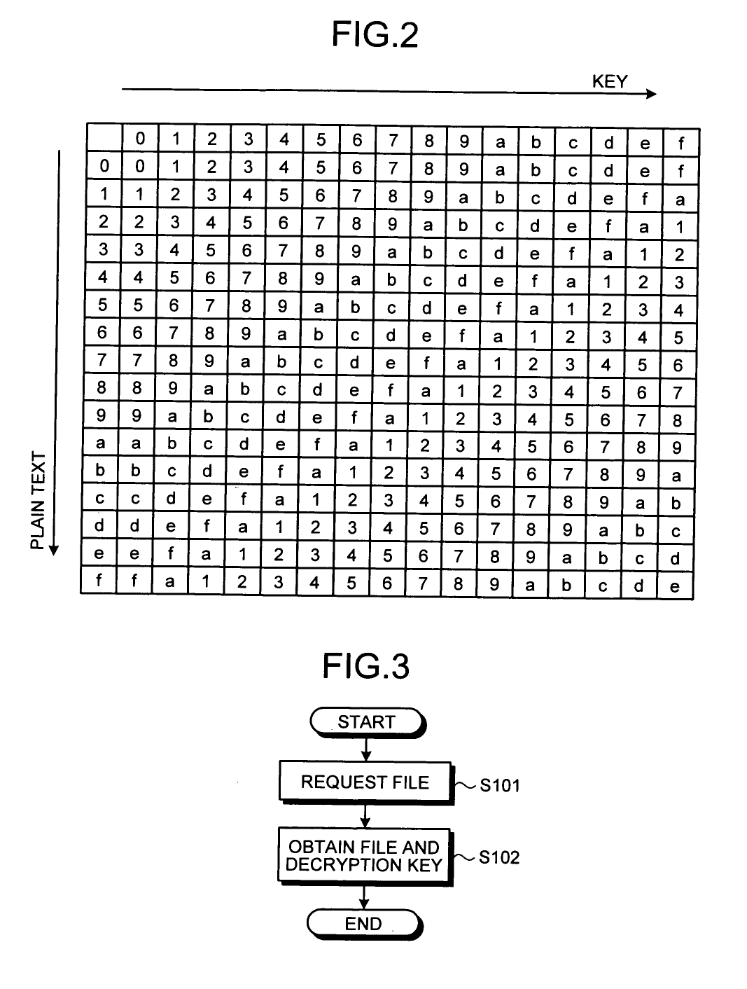

FIG. 2 is a drawing for illustrating a Vigenere square. In the Vigenere cipher scheme, encryption is performed by using the Vigenere square as depicted in FIG. 2. A first row of the Vigenere square represents characters serving as a key, while a first row thereof represents plain text that is to be encrypted. In the key and the plain text of a general Vigenere square, alphabets from A to Z are used. However, since things to be distributed as a file are digital contents, it is assumed for easy of use that the key and the plain text are represented by 0 to f that can represent a hexadecimal notation.

An example of an encryption scheme using this square is explained. For example, when the plain text is “1027e703” and the key is “f301”, a decrypting process for these is performed in the following manner.

Since the first character in this plain text is “1” and the first character of the key is “f”, “a” is obtained by referring to the third row and the seventeenth column in the Vigenere square. Next, since the second character in the plain text is “0” and the second character of the key is “3”, “3” is obtained by referring to the second row and the fourth column in the Vigenere square. Similarly, “2” corresponds to “2”, whilst “7” corresponds to “8”.

For “e” of the fifth character in the plain text, no fifth character is present in the key, and therefore the first character is used again. Therefore, “e” uses “f” as a key. In this manner, the result of the encryption of the plain text “1027e703” with the key “f301” is a first code “a3784a04”. For decrypting the encrypted text, the procedure can be traced in the reverse direction.

Then, “9001” is considered as a second key. This key is decrypted with the first key “f301”. At this time, a character in the plain text whose value after encryption is nine with respect to the key of “f” is “a”. Similarly, when “f301” is decrypted with “9001”, a third key “a300” is obtained. Furthermore, when the first code “a3784a04” obtained through encryption explained above is again encrypted with the third key, a second code “4078ad04” is obtained.

When this second code is decrypted by the third key, the second code becomes the original plain text “1027e703”. That is, a code for the second key can be generated without decrypting the first code. This mechanism is simple. In the first place, the Vigenere square is such that the plain text is shifted by the value of the corresponding key. That is, when a plain text is “x” and a first key is “a”, a first key can be represented as x+a.

On the other hand, when the plain text is encrypted with a second key “b”, a second code is x+b. By contrast, a third key obtained by decrypting the second key with the first key is b−a. That is, a third code is x+a+(b−a)=x+b.

With this, the distributor can allow the transfer to perform encryption without sending a decryption key. Therefore, the decryption key can be protected from theft. The transferring side does not have to perform two processes of decrypting and encrypting, thereby advantageously reducing the amount of process. However, the length of the encryption key has to be constant.

In this manner, according to the embodiment, the encrypted file can be further encrypted without once being decrypted. This can be done because of using the Vigenere cipher scheme as an encryption scheme, as explained above. Therefore, encryption can be easily performed, and the load on each client as a transferor can be reduced.

For easier understanding, the operations of a file requesting client, the transfer management server 1001, and the transfer client are respectively explained in detail below. First, the operation of the file requesting client according to the embodiment is explained by using the drawings.

The identical encryption and decrypting processes are performed in each flowchart explained below. What is transmitted from the transfer management server side to each client is a decryption key, while what is transmitted among the clients is an encryption key.

FIG. 3 is a flowchart of the operation of the file requesting client. The client requesting file transmits a request for distributing a required file to the transfer management server 1001 (step S101). Then, the client requesting file obtains the encrypted required file from the transfer client or the distribution server 1000, and further obtains a decryption key from the transfer management server 1001 (step S102). It is assumed herein that the decryption key can be obtained only when a consideration for the requested file is paid. Here, to actually use the file, the encrypted file obtained from the transfer client or the distribution server 1000 can be decrypted with the decryption key obtained from the transfer management server.

In this manner, except for paying a consideration for the file, the file requesting user only issues a file distribution request to the transfer management server 1001. Therefore, the user can easily obtain the desired film.

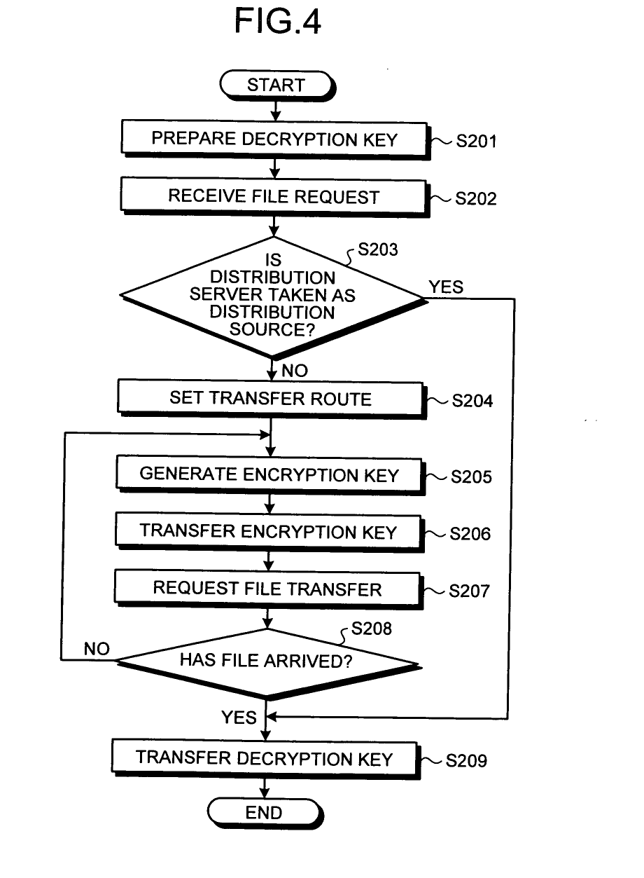

FIG. 4 is a flowchart of the operation of the transfer management server 1001. The transfer management server 1001 prepares an individual decryption key for each transfer client registered in the transfer-client management table (step S201). Upon reception of a file request (file distribution request) from a client (step S202), the transfer management server 1001 determines whether the distribution server 1000 is taken as a file distribution source (step S203). This determination can be made by, for example, determining how many clients to which the file to be distributed has been previously distributed. That is, by referring to the distribution-history management table based on the file requested for distribution, information about clients having the file requested for distribution is obtained, and whether to take the distribution server 1000 as a file distribution source is determined according to how many clients having the file requested for distribution are present.

When the distribution server 1000 is taken as a distribution source (“Yes” at step S203), the decryption key individually prepared in advance at step S201 is transmitted to the requesting client (step S209).

On the other hand, when the distribution server 1000 is not taken as a distribution source (“No” at step S203), a transfer route of the distribution file is set (step S204). A determination of a transfer route includes a determination of transfer clients participating in transfer and a determination of an order of passing through the transfer clients. Once the file transfer route is set, the decryption key for the first transfer client on the transfer route and the decryption key for the next client, that is, the second transfer client on the transfer route are combined to generate an encryption key (step S205). Here, the scheme of generating an encryption key is based on the generating scheme mentioned above.

Upon generation of the encryption key, this encryption key is transferred to the first client on the transfer route (step S206). Furthermore, the first transfer client is notified of the (second) transfer destination to which the file is to be transferred next, and a file transfer request is issued (step S207). Then, it is checked whether the file has arrived at the second client from the first client (step S208).

At this time, if the distribution file has arrived at the file requesting client (“Yes” at step S208), the decryption key prepared at step S201 is transferred to the file requesting client (step S209), and then the procedure ends. On the other hand, if the distribution file has not arrived (“No” at step S208), the procedure goes to step S205, where an encryption key is generated again.

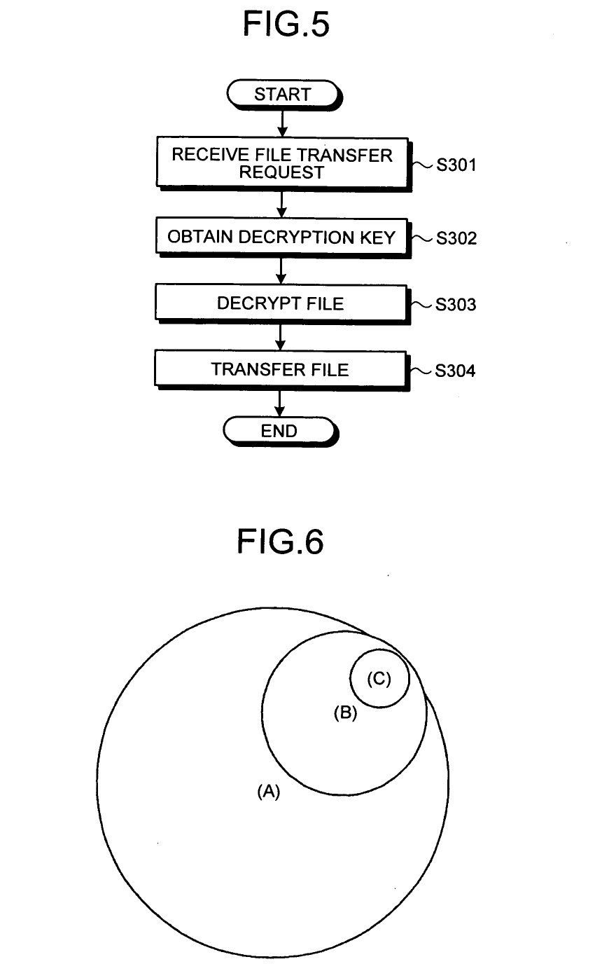

FIG. 5 is a flowchart of the operation of the transfer client. The transfer client receives a file transfer request from the distribution server 1000, the transfer management server 1001, the distribution-source client, or another transfer client (step S301). At this time, the transfer client obtains the decryption key from the transfer management server 1001 (step S302) for decrypting the file (step S303). Then, finally, the decrypted file is transferred to the next transfer-destination client set by the transfer management server 1001 (step S303), and then the procedure ends.

According to the embodiment, when the file distributor transfers the file provided by the distributor to each transferor, how much amount of reward is paid according to the amount of transfer is declared and announced. On the other hand, each client, which is a file receiver and transferor, declares in advance to the transfer management server 1001 intention of participating in a file transfer, by taking the announcement as one of determination criteria. Then, the transfer management server 1001 receiving the declaration from each client registers, for each client in the transfer-client management table, on which conditions (the type or contents of the target file, the amount of reward, or others) the client will participate in transfer as a transfer client.

In this manner, for each client (user), an intention of participation and participation conditions regarding file transfer are checked in advance. With this, the user can be prevented from participating unwanted file sharing. Examples of unwanted file sharing include file sharing with a small amount of reward from the distributor or illegal file sharing.

At this time, instead of specifying individual files, grouping for participating in file transfers according to various conditions is more preferable. Such conditions for grouping include, for example, a condition in which the file to be transferred is a music file and a condition in which the file to be transferred is a file provided by a certain company. In this manner, with grouping for participating in transfer, the amount of transfer of files can be managed, and a user's intention of not participating in a specific file distributor can be reflected, thereby increasing the convenience of the user.

As explained above, according to the file distribution system and file distribution method of the embodiment, in a file distribution system using a P2P communication scheme, a file distributor can inexpensively distribute files without impairing its benefit.

Even in the conventional technology, the P2P file distribution of can significantly reduce the load on the distribution server compared with the client-server scheme, and therefore is suitable for distributing a large amount of files. However, the P2P file distribution has problems of a small merit for the transferor in participating in communication and possible illegal sharing.

By contrast, in the file distribution system according to the embodiment, a reward first is given to the transfer client to increase the merits for the transferor in participating in communication. Also according to the embodiment, an effect of avoiding the demerit of possible use for illegal sharing can be achieved, which is explained in detail below.

According to the embodiment, instead of using the pure P2P scheme, the hybrid P2P scheme is used for transfers, thereby managing file transfers. Therefore, the possibility of use for illegal file distribution or sharing is lower than that of the pure P2P scheme. Also, since encryption is performed for each file separately, the possibility of use for illegal file distribution or sharing is further lower.

However, it is impossible to inhibit some users from illegal distribution or sharing of both of the file and decryption key or the decrypted file by using another pure P2P scheme or the like. According to the embodiment, if a person has a file and participates in a transfer, a reward can be obtained from the file distributor. If a user illegally distributes or shares a file, this user loses an opportunity of obtaining a reward, and therefore an effect of inhibiting illegal distribution or sharing can be achieved.

Furthermore, the embodiment has an effect of increasing sales of files. This is because a reward is given to the file transferor according to the embodiment. Here, the reward may be actual money or may be a point that can be used only in the file distribution system according to the embodiment. In any case, the price of a file is practically decreased by automatically-accumulated rewards.

In normal circulation of commodity, among users in a user layer desiring a commodity ((A) in FIG. 6), only the users in a user layer ((C) in FIG. 6) willing to pay the price set by the dealer purchase the commodity. As the price is cheaper, a circle represented by (C) in FIG. 6 becomes larger, like a circle represented by (B) in FIG. 6, to more closely resemble a circle represented by (A) in FIG. 6.

In the file distribution system according to the embodiment, for the users participating in transfer, the price eventually becomes zero if they just spend time. On the other hand, from the distributor's point of view, the circle represented by (C) in FIG. 6 can be changed to the circle represented by (A) in FIG. 6. That is, sales of files can be increased.

Here, in an extreme theory, a user obtaining a file through illegal file sharing uses the file because the file can be obtained for free, and if the file cannot be obtained for free, such a user does not use that file, to begin with.

In the file distribution system according to the embodiment, when rewards are accumulated to a certain amount, a file can be obtained free. Even if such a certain amount of rewards as to allow obtainment of a file for free has not yet been accumulated, a discount is given, for example, at the time of obtaining a file. Therefore, users who desire to obtain a file for free or users who obtain a file at a discount, that is, users who desire to obtain a file even illegally, can be covered as a constituency, thereby further increasing sales.

From the explanation above, monetary values seem to be exchanged only between users and the distributor, but this is not the case. This is because, as mentioned above, “the price goes down as time goes by”. Although depending on how much reward is paid to the transfer client, in practice, when a file desired by the user is present, the user does not always have rewards obtained through transfer.

For the purpose of explanation, distribution of a music file is taken as an example herein, and it is assumed that, for a user 1, the music file is the one currently desired, but for a user 2, the music file is the one desired after a lapse of certain times and days, that is, the one that is not immediately required but will be desired later.

In this case, when the user 1 makes a request for that file, the user 1 immediately makes a request (purchases) the file irrespectively of the reward obtained through transfer. On the other hand, the user 2 does not require the file at this point in time, but will request the file sooner or later. At the time of request by the user 2, a certain time has elapsed after the time of the file request by the user 1. As mentioned above, in general, since “the price goes down as time goes by”, the user 2 can purchase the file at a lower price than that of the user 1.

However, even in this case, as with the user 1, a user in the layer of (C) in FIG. 6 will purchase the file irrespectively of the reward obtained through transfer, that is, by using monetary values other than the reward obtained through transfer. Therefore, the amount of monetary values exchanged over the system is increased in itself.

In the invention disclosed in the gazette explained above, the reward obtained by the transferor is not passed within the system, and only an increase in price is provided to the users. On the other hand, as has been explained, in the file distribution system according to the embodiment, since the receiver is also a transferor, the price of the file posted by the distributor as a circulation cost is paid to the receiver, which is also a transferor. Therefore, the price is not practically increased. Furthermore, since various constituencies as depicted in FIG. 6 can be covered, there is a significant merit also to the distributor.

According to the embodiment, explanation has been made with one distribution server and one server acting as both of a distribution management server and a reward management server. This is not meant to be restrictive, and no problem arises as long as these functions are provided to the system. These servers may be separately present, or the functions may be performed by one server. As a matter of course, no problem arises with a different number of transfer management servers, a different number of distribution servers, and a different number of reward management servers.

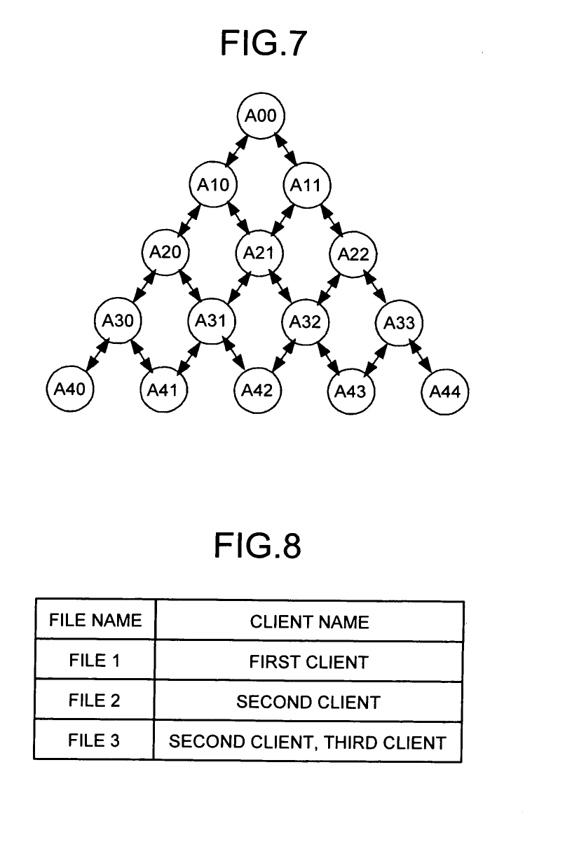

Furthermore, in the file distribution system according to the embodiment, the load on the management server can be further reduced. This is explained by using FIG. 7.

First, as a premise, users participating in the file distribution system according to the embodiment as file transferors or file receivers are registered in a management server, thereby each obtain an identifier. Next, a file distributor recruits primary transferors of a file to be distributed, and the file is distributed in advance to the transferors from the distribution server. At this time, the file is encrypted by using a Vigenere cipher scheme using a specific encryption key. Then, the identifier of each of the primary transferors is added to a part of the file.

For the users to participate in the file distribution system, an application installed in advance is first started. Upon start of the application, a user becomes any one of nodes represented by A00 to A44 in a virtual network as depicted in FIG. 7. The nodes in each stage each ascertain which file is present at a node there under. Here, for the purpose of explanation, it is assumed that a user participates in the network as A44.

The user desiring a specific file issues a request to a node A33 at an upper stage. If either one of A43 and A44 that can hang down from the node at the upper stage has the file, a request is issued to the relevant node, and the file is transferred to A44 as the user himself or herself as a transferor. In the course of this transfer, at each transfer source, the identifier of the transfer destination is obtained from the transfer-destination node, and is then added to a part of the file. Similarly, if A33 does not have information, a request is issued to A22. If A 22 does not have information, a request is further issued to A11 for file search.

When the desired file cannot be found even with the file searching scheme explained above, the user once gets out of this currently-connected virtual network, and then again connects to another virtual network. By repeating such an operation, the file is found and obtained. The transfer file finally obtained by the user desiring that file has written therein all client identifiers participating in transfer.

When the user desiring the file desires to use this file, the user obtains a key by paying a consideration for that file to the management server. At this time, the identifiers of the clients participating in transfer are sent to the management server, the clients participating in a transfer each obtain a right of evenly receiving a reward defined in advance by the distributor.

That is, a reward is not given to the transferor until the file is purchased. With this, circulation cost can be suppressed within an arbitrary amount, thereby allowing the file distributor to easily use the file distribution system according to the embodiment. Also, the reward defined in advance by the file distributor is evenly divided. With this, circulation cost can be made constant. Also, the number of transferors can be completely indefinite, thereby further concealing personal information of people desiring the file.

According to the embodiment, no server manages the locations of files. Therefore, to search for a desired file, in a straightforward manner, the desired file has to be broadcast to PCs around the world. In that case, the network may possibly be saturated only with search information. To get around this, a virtual network as explained above is used.

As explained above, according to one embodiment of the present invention, the load on the management server can be considerably reduced. On the other hand, it is impossible to perform a different encryption for each user, and therefore the encryption key may possibly be shared illegally. However, for the users participating in a transfer, sharing the key poses a demerit of losing their own rewards supposed to be obtained through a transfer, as explained above. Therefore, illegal sharing can be suppressed.

Furthermore, according to another embodiment of the present invention, in a file distribution system using a P2P communication scheme, a file distributor can inexpensively distribute files without impairing its benefit.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A system having a server to manage a distribution of a file and at least two client devices including a first client device to request the file and a second client device to transfer the file are mutually connected via a network, wherein
the second client device includes
a storing unit to store therein the file distributed by the server, and
a transferring unit to transfer the file to the first client device, and
the server includes
a managing unit to manage the file,
a distributing unit to distribute the file in response to a request from the first client device, and
a reward managing unit to manage a reward for a transfer of the file to be issued to the second client device that participated in the transfer of the file.

2. The system according to claim 1, wherein the server further includes an encryption-key transmitting unit to generate a unique encryption key for the second client device, and to transmit generated encryption key to the second client device.

3. The system according to claim 2, wherein
the file distributed from the server is encrypted based on a unique encryption key for the server, and
the file transferred from the second client device is encrypted based on the unique encryption key for the second client device.

4. The system according to claim 3, wherein encrypted file can be re-encrypted without being decrypted.

5. The system according to claim 4, wherein the file is encrypted by using a Vigenere cipher scheme.

6. The system according to claim 1, wherein a distribution source of the file sets a range of number of second client devices participating in the transfer of the file.

7. The system according to claim 6, wherein the number of second client devices that transfer the file is a number randomly determined within the range of the number of second clients set by the distribution source.

8. The system according to claim 1, wherein the server further includes a reward notifying unit to notify, when a reward is issued for the transfer of the file, the second client device receiving the reward of an issuance of the reward.

9. The system according to claim 3, wherein upon decrypting encrypted file, the first client device adds information specific to the first client device to the file after decrypting.

10. A method of distributing a file to a first client device that requests the file by transferring the file from a server that distributes the file, through a network, the method comprising:
file distributing including the server distributing the file, when a request for the file is received from the first client device, to a second client device that transfers the file to the first client device;
file transferring including the second client device transferring the file to the first client device; and
reward issuing including the server issuing a reward to second client devices that participated in a transfer of the file.

11. The method according to claim 10, further comprising encryption-key transmitting including the server generating a unique encryption key for the second client device and transmitting generated encryption key to the second client device.

12. The method according to claim 11, wherein
the file distributed from the server is encrypted based on a unique encryption key for the server, and
the file transferred from the second client device is encrypted based on the unique encryption key for the second client device.

13. The method according to claim 12, wherein encrypted file can be re-encrypted without being decrypted.

14. The method according to claim 13, wherein the file is encrypted by using a Vigenere cipher scheme.

15. The method according to claim 10, wherein a distribution source of the file sets a range of number of second client devices participating in the transfer of the file.

16. The method according to claim 15, wherein the number of second client devices that transfer the file is a number randomly determined within the range of the number of second clients set by the distribution source.

17. The method according to claim 10, further comprising reward notifying including the server notifying, when a reward is issued for the transfer of the file, the second client device receiving the reward of an issuance of the reward.

18. The method according to claim 12, wherein upon decrypting encrypted file, the first client device adds information specific to the first client device to the file after decrypting.
